(19) United States
(12) Patent Application Publication
(10) Pub. No.: US 2017/0366868 A1
(43) Pub. Date: Dec. 21, 2017

(54) IMAGING DEVICE, IMAGING METHOD, AND NON-TRANSITORY STORAGE MEDIUM

(71) Applicant: JVC KENWOOD Corporation, Yokohama-shi (JP)

(72) Inventor: Kunio Otsuka, Yokohama-shi (JP)

(21) Appl. No.: 15/620,927

(22) Filed: Jun. 13, 2017

(30) Foreign Application Priority Data
Jun. 17, 2016 (JP) 2016-120962

(51) Int. Cl. H04N 21/60; F17D 5/06; H04N 21/20; G01S 7/52

(52) U.S. Cl. CPC H04N 21/60; F17D 5/06; H04N 21/20; G01S 7/52053

(57) ABSTRACT

An imaging device comprises: an imager configured to image a target; a main-body display configured to display thereon image information acquired by the imager; a main-body communicator configured to communicate with external equipment including a display via a network; a storage configured to store therein the acquired image information and information for indicating a predetermined content; and a display controller configured to cause the display or the main-body display to display thereon the information for indicating the predetermined content.

### CROSS-REFERENCE TO RELATED APPLICATION

The present application claims priority to and incorporates by reference the entire contents of Japanese Patent Application No. 2016-120962 filed in Japan on Jun. 17, 2016.

### FIELD

The present invention relates to an imaging device capable of communicating with external equipment, an imaging method, and a non-transitory storage medium.

### BACKGROUND

In general, for inspecting interior regions of subjects to be inspected (targets) such as industrial equipment and piping, endoscopes are widely used as imaging devices that are inserted into the interior regions and image subjects to be imaged in the interior regions. In this industrial endoscope, presence or absence of scratch and corrosion of the subject to be imaged in the interior region is observed with acquired images of the subject (for example, refer to Japanese Patent Application Laid-open No. 2000-162510). For medical endoscopes, a technique is disclosed that causes a head mounted display to display an acquired image (For example, refer to Japanese Patent Application Laid-open No. H08-131399).

Conventionally, when inspecting the interior region of the subject to be inspected, an inspector uses an inspection procedure manual describing an inspection procedure on paper and operates an endoscope in accordance with working contents specified in the inspection procedure manual for respective processes. When the inspection progresses to the next process, the inspector needs to confirm the required working contents of the next process with reference to the inspection procedure manual. This confirmation of the required working contents of the next process increases a work load for the inspector in the inspection.

### SUMMARY

An imaging device capable of communicating with external equipment, an imaging method, and a non-transitory storage medium are disclosed.

According to one aspect, there is provided an imaging device, comprising: an imager configured to image a target; a main-body display configured to display thereon image information acquired by the imager; a main-body communicator configured to communicate with external equipment including a display via a network; a storage configured to store therein the acquired image information and information for indicating a predetermined content; and a display controller configured to cause the display or the main-body display to display thereon the information for indicating the predetermined content.

According to one aspect, there is provided an imaging method that is used by an imaging device including an imager that images a target and a main-body display that displays thereon image information acquired by the imager, the imaging method comprising: communicating with external equipment including a display via a network; storing the acquired image information and information for indicating a predetermined content; and causing the display or the main-body display to display thereon the information for indicating the predetermined content.

According to one aspect, there is provided a non-transitory storage medium that stores therein an imaging program executed by an imaging device including an imager that images a target and a main-body display that displays image information acquired by the imager, the imaging program comprising: communicating with external equipment including a display via a network; storing the acquired image information and information for indicating a predetermined content; and causing the display or the main-body display to display thereon the information for indicating the predetermined content.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a functional configuration diagram of an inspection apparatus including an endoscope according to an embodiment;

FIG. 2 is a flowchart illustrating a procedure for storing an image in association with procedure manual information;

FIG. 3 is a flowchart illustrating a procedure of association processing;

FIG. 4 is a flowchart illustrating a procedure of inspection operation; and

FIG. 5 is a flowchart illustrating an operation procedure of a determinator.

### DETAILED DESCRIPTION OF THE PREFERRED EMBODIMENTS

The following describes embodiments according to the present application in detail with reference to the accompanying drawings. The embodiments do not limit the application. The constituent elements of the following embodiments include elements that can be easily replaced with substitute elements by a person skilled in the art or elements that are substantially the same as each other.

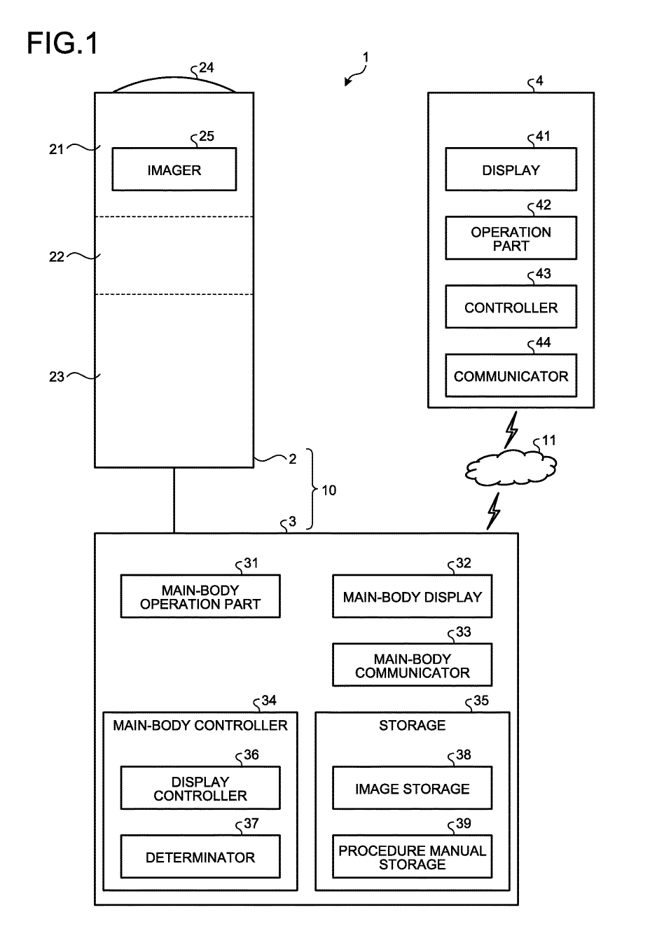

FIG. 1 is a functional configuration diagram of an inspection apparatus including an endoscope according to the embodiments. As illustrated in FIG. 1, this inspection apparatus 1 includes an endoscope 10 serving as an imaging device and a head mounted display (external equipment) 4 that is coupled to the endoscope 10 via a network 11 such as a local area network (LAN) so as to be able to communication with the endoscope 10. The inspection apparatus 1 inspects an interior region of a subject to be inspected (target) by inserting the endoscope 10 into the interior region. Examples of the subject to be inspected include industrial equipment such as a generator and an engine, a turbine, and various types of piping.

The endoscope 10 includes an endoscope insertion part 2 formed in an elongate tubular shape and a control unit 3 that operates and controls the endoscope insertion part 2. The endoscope insertion part 2 includes a head part 21 that is inserted into the interior region (not illustrated) of the subject to be inspected, a bending part 22 that is connected to the head part 21 and is bendable freely to change a direction of the head part 21, and an elongate flexible tube part 23 that is connected to the bending part 22. The head part 21 is formed of a material with a certain degree of hardness such as a resin or a metal. The head part 21 includes a lens 24 provided at the front end thereof and an imager 25. The imager 25 acquires an image of the subject to be imaged in the interior region into which the endoscope 10 is inserted. The acquired image may be a still image or a moving image. In the embodiment, the head part 21 is provided with the lens 24 at the front end thereof. Instead, the head part 21 may be provided with a transparent window formed of a transparent material (e.g., an acrylic resin or a glass) at the front end thereof while the lens 24 may be provided between the transparent window and the imager 25. The head part 21 may be provided with at least one lighting part (not illustrated) around the outer periphery of the lens 24. Instead, when the head part 21 is provided with the transparent window at the end thereof, the lighting part may be provided inside the head part 21.

The bending part 22 is composed of a plurality of joint segments, for example. To the joint segment on the front end side of the bending part 22, multiple wires (not illustrated) are fixed at a certain angular interval. The bending part 22 can be bent, by pulling some of the wires arranged at the certain angular interval, in a certain direction corresponding to the pulled wires. In the embodiment, the bending part 22 can bend the head part 21 in any direction of 360 degrees. The bent angle of the head part 21 is equal to or larger than 90 degrees.

The flexible tube part 23 is a hollow tubular member having flexibility. The flexible tube part 23 houses signal wires and power wires connected to the imager 25 of the head part 21 and the multiple wires connected to the joint segment of the bending part 22, for example.

The control unit 3 includes a main-body operation part 31, a main-body display 32, a main-body communicator 33, a main-body controller 34, and a storage 35. The main-body operation part 31 has a function to operate the endoscope insertion part 2 to move. The main-body operation part 31 includes a physical operation part such as a joy stick or operation switches and an electronic operation part such as a touch panel, for example. In the embodiment, the main-body operation part 31 operates the bending part 22 of the endoscope insertion part 2 such that the bending part 22 is bent in a certain direction, for example. The main-body operation part 31 may have a function to perform operation concerning display of the head mounted display 4.

The main-body display 32 has a display function to display various types of information thereon. The main-body display 32 displays image information acquired by the imager 25, for example. The main-body communicator 33 is connected to the network 11. The main-body communicator 33 exchanges various types of information with the head mounted display 4 connected to the network 11 through communication therebetween. In the embodiment, the main-body communicator 33 performs communication via the network 11 using a wireless communication means (e.g., Wi-Fi or Bluetooth (registered trademark)). Various types of information may be communicated using a wired communication means. The main-body communicator 33 may communicate various types of information via a relaying device (not illustrated) which serves as a network access point. In this case, the communication between the main-body communicator 33 and the relaying device may be performed using the wired communication means while the communication between the relaying device and the head mounted display 4 may be performed using the wireless communication means.

The main-body controller 34 controls the whole operation of the control unit 3. The main-body controller 34 includes a display controller 36 and a determinator 37. The display controller 36 controls a displayed content displayed on the main-body display 32 based on the image information acquired by the imager 25, for example. The display controller 36 also controls a displayed content displayed on the head mounted display 4 connected to the network 11. Based on multiple pieces of image information of the same subject to be imaged acquired at certain time intervals, the determinator 37 determines whether damage such as scratch or corrosion has occurred on the subject over time.

The storage 35 stores therein various types of information under the control of the main-body controller 34. The storage 35 mainly includes an image storage 38 and a procedure manual storage 39. The procedure manual storage 39 stores therein procedure manual information based on an inspection procedure manual in which a procedure of the inspection performed on the subject to be inspected is specified. The inspection procedure manual describes inspection procedures of the subject to be inspected for each process and specifies working contents (e.g., operation of the endoscope 10, confirmation items, and precautions) for each process. The procedure manual information is information (predetermined information) that indicates contents of the inspection procedure manual aimed to be displayed on the head mounted display 4. The procedure manual information is text information in which the contents of the inspection procedure manual are represented in texts that can be displayed on the head mounted display 4 or video information in which the contents of the inspection procedure manual are represented in videos, for example. The procedure manual information may be prepared for each process or on a multiple process basis. The use of the inspection procedure manual in which the processes of the inspection procedure and the working contents of the respective processes are specified makes it possible for even an unskilled inspector to perform inspection with performance exceeding a certain standard.

The image storage 38 stores therein the image information acquired by the imager 25. In the embodiment, the image storage 38 stores therein the process of the inspection procedure in the inspection procedure manual, the image information acquired during the process, and the date at which the process is performed in association with each other. The storing thereof in the image storage 38 is performed with an inspector's confirmation operation under the control of the main-body controller 34. Since the process of the inspection procedure, the acquired image information, and the imaging date are stored in association with each other as described above, it is possible to easily manage a history of the image information at the same process.

The head mounted display 4 is information equipment to be worn on a head of the inspector. The head mounted display 4 includes a display 41, an operation part 42, a controller 43, and a communicator 44. The display 41 is disposed in front of eyes of the inspector when the inspector wears the head mounted display 4 on his/her head. The display 41 displays various types of information presented to the inspector. In the embodiment, the display content of the display 41 is controlled by the display controller 36 of the control unit 3. The display controller 36 displays, on the display 41, the process of the inspection procedure and the working contents for each process based on the procedure manual information. The processes of the inspection procedure are, thus, sequentially displayed on the display 41, which allows the inspector to easily confirm the respective processes. Thus the work load for the inspector in the inspection work can be reduced to allow the inspector to concentrate the inspection work. In the embodiment, since the processes of the inspection procedure are sequentially displayed on the display 41 of the head mounted display 4, the inspector can confirm the respective processes while operating the endoscope 10 using both hands and perform the inspection efficiently.

The operation part 42 operates the head mounted display 4. The operation part 42 includes a joy stick and operation switches, for example. In the embodiment, the operation part 42 can operate the control unit 3 via the network 11. Specifically, the operation part 42 includes a voice recognition part (not illustrated), thereby transmitting an operation command corresponding to a voice (voice command) by the inspector to the control unit 3. This structure allows the confirmation operation to be performed by the voice (voice command) by the inspector when the acquired image information is stored in the image storage 38 in association with the process, for example. The operation part 42 may have a function to perform operation concerning the display of the head mounted display 4.

The controller 43 controls the operation of the head mounted display 4 and the control unit 3 in cooperation with the main-body controller 34 of the control unit 3. The communicator 44 is connected to the network 11. The communicator 44 exchanges various types of information with the control unit 3 connected to the network 11 through communication therebetween. The communicator 44 may exchange various types of information with the control unit 3 using a wireless communication method or a wired communication method, or via a relaying device like the control unit 3 as described above.

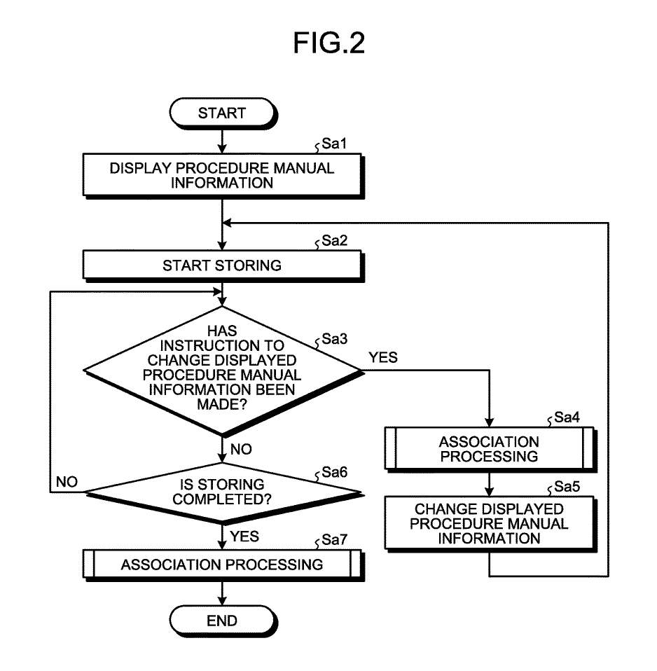

The following describes a procedure to be performed by the inspection apparatus 1 to store an image in association with the procedure manual information. FIG. 2 is a flowchart illustrating a procedure for storing the image in association with the procedure manual information.

Based on an instruction from the main-body operation part 31 or the operation part 42, the controller 43 reads the procedure manual information from the procedure manual storage 39 and displays the procedure manual information on the display 41 (step Sa1). When the step is performed based on the instruction from the operation part 42, the communicator 44 transmits a signal for the instruction to the main-body communicator 33 and the controller 43 displays the procedure manual information based on the signal. The displayed procedure manual information is text information, for example. The controller 43 displays that “First process: Insert the head part of the endoscope inside the pipe downward by 50 cm. Is the insertion completed?” on the display 41.

Based on an instruction from the main-body operation part 31 or the operation part 42, the main-body controller 34 starts the operation of storing an image acquired by the imager 25 in the image storage 38 (step Sa2). An example of the image is an image of the inside of the pipe acquired as the subject to be imaged.

The main-body controller 34 determines whether an instruction to change the procedure manual information displayed on the display 41 to other procedure manual information has been made by the main-body operation part 31 or the operation part 42 (step Sa3). More specifically, the instruction is to change the procedure manual information “First process: Insert the head part of the endoscope inside the pipe downward by 50 cm. Is the insertion completed?” displayed on the display 41 to other procedure manual information “Second process: Bend the head part of the endoscope in the right direction by 90 degrees in the pipe and image the subject to be imaged while this state is maintained. Is the imaging completed?”

When it is determined at step Sa3 that the instruction to change the procedure manual information displayed on the display 41 to other procedure manual information has been made (Yes at step Sa3), the main-body controller 34 performs association processing, which is described later, (step Sa4). After the association processing is performed, the main-body controller 34 changes the procedure manual information displayed on the display 41 to the other procedure manual information (step Sa5). Thereafter, the main-body controller 34 starts the operation of storing the image in the image storage 38 again.

If it is determined at step Sa3 that no instruction to change the procedure manual information displayed on the display 41 to other procedure manual information has been made (No at step Sa3), the main-body controller 34 determines whether an instruction to end the storing of the image in the image storage 38 has been made by the main-body operation part 31 or the operation part 42 while continuing to store the image in the image storage 38 (step Sa6).

If it is determined at step Sa6 that the instruction to end the storing of the image in the image storage 38 has been made (Yes at step Sa6), the main-body controller 34 performs the association processing, which is described later, (step Sa7), and thereafter ends the storing of the image in the image storage 38. If it is determined at step S6 that no instruction to end the storing of the image in the image storage 38 has been made (No at step S6), the main-body controller 34 continues to store the image in the image storage 38.

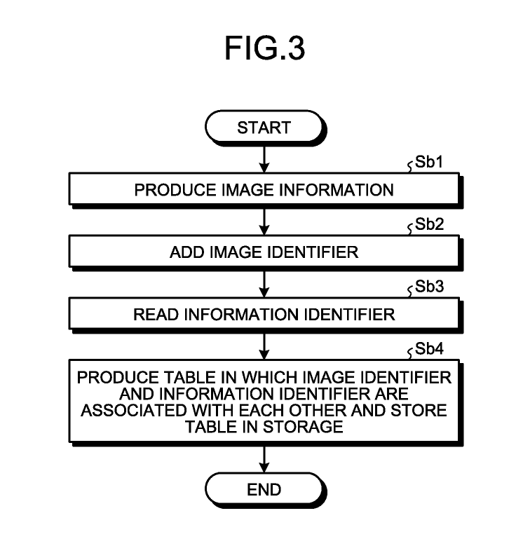

The following describes the association processing performed at step Sa4 and step Sa7. FIG. 3 is a flowchart illustrating a procedure of the association processing. The main-body controller 34 produces the image information in the image storage 38 using the images stored in the image storage 38 from the start of the storing of the image to the start of the association processing (step Sb1). The image information is a moving image file, for example.

The main-body controller 34 adds an image identifier for identifying the image information to each of the pieces of produced image information (step Sb2). More specifically, the main-body controller 34 adds the image identifier according to a predetermined rule to the image information with reference to the storage 35. The predetermined rule is a rule by which the image identifier is individually added to each piece of image information for identifying the piece of image information. The storage 35 stores therein the predetermined rule and the pieces of the image information with the image identifiers. For example, “00A1” is added as the image identifier to certain image information and “00A2” is added as the image identifier to the next image information. The image identifier can be added to the image information by storing the image identifier in the header of the image information.

The main-body controller 34 reads an information identifier for identifying the procedure manual information from the procedure manual information displayed on the display 41 when the association processing is performed (step Sb3). The information identifier is prepared for each piece of the procedure manual information and preliminarily added thereto. For example, “00B1” is added to a first procedure manual information as the information identifier and “00B2” is added to a second procedure manual information as the information identifier.

The main-body controller 34 produces a table in which the image identifier and the information identifier are associated with each other and stores the table in the storage 35 (step Sb4). More specifically, the main-body controller 34 produces the table in which the image identifier “00A1” added to the produced image information and the information identifier “00B1” read from the procedure manual information displayed on the display 41 are associated with each other, and stores the table in the storage 35.

The association processing produces the table in which the added image identifier and the read information identifier are associated with each other. The association processing may associate the file name of the image with the file name of the procedure manual information. In this case, reading the file name of the image and the file name of the procedure manual information replaces adding the image identifier and reading the information identifier.

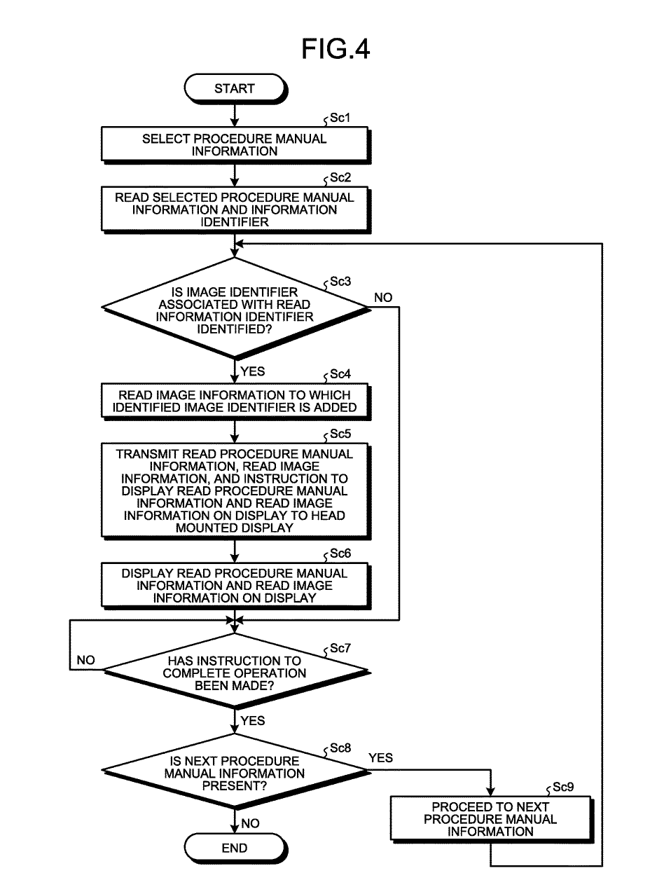

The following describes a procedure of the inspection operation using the inspection apparatus 1. FIG. 4 is a flowchart illustrating a procedure of the inspection operation. The embodiment exemplarily describes a procedure of the inspection operation after the table is produced in which the information identifier and the image information identifier are associated with each other as described above. Based on an instruction from the main-body operation part 31, the main-body controller 34 selects the procedure manual information (step Sc1). Specifically, the main-body controller 34 displays a selection screen from which each piece of procedure manual information can be selected on the main-body display 32 and selects any of the procedure manual information according to the instruction from the main-body operation part 31. In this example, an item indicating the procedure manual information “First process: Insert the head part of the endoscope inside the pipe downward by 50 cm. Is the insertion completed?” is selected.

The main-body controller 34 reads the selected procedure manual information from the procedure manual storage 39 and reads the information identifier of the selected procedure manual information (step Sc2). The main-body controller 34 refers to the table stored in the storage 35 and determines whether the image identifier associated with the read information identifier is identified (step Sc3). If it is determined at step Sc3 that the image identifier associated with the read information identifier is identified (Yes at step Sc3), the main-body controller 34 reads the image information to which the identified image identifier is added from the image storage 38 (step Sc4). If the image identifier associated with the read information identifier is not identified (No at step Sc3), the procedure proceeds to step Sc7 to determine whether an instruction to complete the operation has been made.

The main-body controller 34 transmits the read procedure manual information and the read image information to the head mounted display 4 via the main-body communicator 33 and the communicator 44, and transmits an instruction to display the read procedure manual information and the read image information on the display 41 to the controller 43 as a signal (step Sc5). Based on the signal, the controller 43 displays the read procedure manual information and the read image information on the display 41 (step Sc6). When the display 41 has two displays, the procedure manual information and the image information may be displayed separately on two displays, or the procedure manual information and the image information may be displayed on one display. The procedure manual information and the image information do not need to be displayed all over the display, and may be displayed on a partial region of the display.

Specifically, the main-body controller 34 reads the procedure manual information for indicating that “First process: Insert the head part of the endoscope inside the pipe downward by 50 cm. Is the insertion completed?” and reads the information identifier “00B1” added to the procedure manual information. The main-body controller 34 refers to the table stored in the storage 35, identifies the image identifier “00A1” associated with the information identifier “00B1”, and reads the image information to which this identified image identifier is added from the image storage 38. Thereafter, the main-body controller 34 transmits the read procedure manual information, the read image information, and a signal for instructing the display of the read procedure manual information and the read image information to the head mounted display 4. The controller 43 displays the read procedure manual information “First process: Insert the head part of the endoscope inside the pipe downward by 50 cm. Is the insertion completed?” in a first region on the display 41 of the head mounted display and displays the read image information in a second region on the display 41. On the main-body display 32, an image being acquired by the endoscope 10 is displayed.

The main-body controller 34 determines whether a signal for indicating completion of the operation is received from the head mounted display 4 through the main-body communicator 33 and the communicator 44 (step Sc7). The inspector inserts the head part 21 of the endoscope insertion part 2 inside the pipe downward by a distance of 50 cm from the entrance of the pipe according to the procedure manual information displayed on the display 41. When the insertion is completed, the inspector utters a voice command such as “Yes” or “OK” to transmit the signal for indicating the completion of the operation. If no signal for indicating the completion of the operation is received (No at step Sc7), the main-body controller 34 waits for receiving the signal. If the signal for indicating the completion of the operation is received (Yes at step Sc7), the main-body controller 34 determines whether the next procedure manual information following the displayed procedure manual information is present (step Sc8). The next procedure manual information means procedure manual information preliminarily associated with the displayed procedure manual information.

If it is determined that the next procedure manual information is not present (No at step Sc8), the procedure ends. If the next procedure manual information is present (Yes at step Sc8), the procedure proceeds to the next step (step Sc9) to return to step Sc3.

In a specific example of a case when the procedure returns to step Sc3 again, the display controller 36 displays, in the first region (not illustrated) on the display 41, the next procedure manual information “Second process: Bend the head part of the endoscope in the right direction by 90 degrees in the pipe and image the subject to be imaged while this state is maintained. Is the checking completed?” The display controller 36 reads the image information associated with the procedure manual information as described above, and displays the read image information in the second region (not illustrated) on the display 41. According to this structure, the past image information for the subject to the imaged is displayed on the display 41. Thus the inspector can easily perform the present imaging operation with reference to the displayed past image information.

When displaying the image information in a certain region on the display 41, the display controller 36 displays elapsed time information from the storage of the image to the present time together with the image information. According to this structure, the inspector can easily determine whether the inspection is performed within a specified period.

When the subject to be imaged is imaged and the confirmation of the acquired image information is completed, the inspector utters a voice command such as “Yes” or “OK” to transmit the signal for indicating the completion of the operation. In this case, under the control of the main-body controller 34, the image storage 38 stores therein the table in which the information identifier of the procedure manual information and the image identifier of the image information are associated with each other or imaging date information in association with the image information. This allows the history of the image information in an identical process to be easily and correctly managed.

When multiple pieces of the image information are associated with the same procedure manual information and the information identifier of the procedure manual information is read, all or some of the image identifiers corresponding to the information identifier may be read to display the image information with the read image identifiers in a certain region on the display 41 or the main-body display 32 as thumb nail images.

In the embodiments, since the inspector's confirmation operation is performed by the voice command by the inspector, the confirmation operation can be easily performed. The confirmation operation may be performed by the operation of the main-body operation part 31 of the control unit 3.

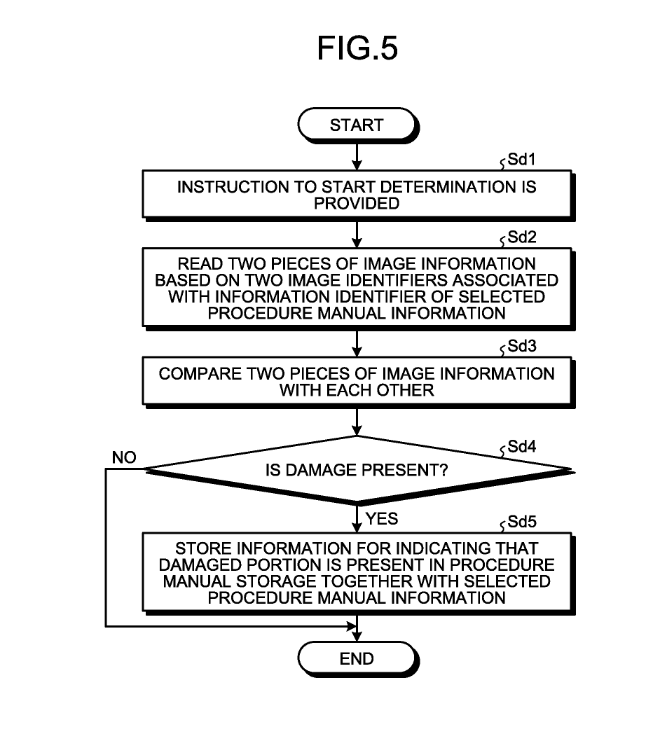

The following describes an operation of the determinator 37. FIG. 5 is a flowchart illustrating an operation procedure of the determinator. When multiple pieces of image information are associated with the same procedure manual information, the determinator 37 determines based on these pieces of image information whether damage (a point of change) such as scratch or corrosion has occurred on the subject. This determination operation can be performed separately from the procedure illustrated in FIG. 4.

When an instruction to start a determination for the selected procedure manual information is provided by the inspector or an inspection manager, for example (step Sd1), the determinator 37 refers to the table stored in the storage 35 and reads multiple pieces of image information from the image storage 38 based on multiple (e.g., two) image identifiers associated with the information identifier of the selected procedure manual information (step Sd2). In this case, the read image information preferably includes the image information stored in the past.

The determinator 37 compares the two pieces of read image information using an image processing technique such as matching (step Sd3). In this case, a target portion to be compared may be preliminarily set or determined by the determinator 37 by extracting a largely changed portion based on the image information.

The determinator 37 determines whether damage has occurred in the compared target portion (step Sd4). For example, when a part of the target portion in which the image has largely changed is extracted based on multiple pieces of image information, it is determined that the damage has occurred. If the determinator 37 determines that no damage has occurred (No at step Sd4), the procedure ends. If it is determined that the damage has occurred (Yes at step Sd4), the determinator 37 stores information for indicating that a damaged portion is present together with the selected procedure manual information in the procedure manual storage 39 (step Sd5). In this case, the determinator 37 outputs information for indicating that the damaged portion is present in relation to the selected procedure manual information to the display controller 36. The display controller 36 displays, on the main-body display 32, information for indicating that the damaged portion is present, as the determination result. In the procedure, information for indicating that the damaged portion is present is stored in the procedure manual storage 39 when it is determined that the damage has occurred. Instead, the information for indicating that the damaged portion is present may be stored in the procedure manual storage 39 by the inspector's or inspection manager's operation based on the display of the determination result.

As a result, the information for indicating that the damaged portion is present is displayed on the display 41 of the head mounted display 4 in the next inspection. The inspector thus can perform the inspection work while paying attention to the damaged portion. As a result, the inspection accuracy can be easily increased.

In the embodiment, the display 41 displays thereon the procedure manual information and the image information associated with the procedure manual information while the main-body display 32 displays thereon the image being acquired by the endoscope 10. Each of them may be displayed on any one of the displays.

The endoscope 10 according to the embodiments includes the imager 25 that images a target, the main-body display 32 that displays the acquired image information, the main-body communicator 33 that communicates with the head mounted display 4 having the display 41 via the network 11, the storage 35 that stores therein the acquired image information and the procedure manual information specifying the inspection procedure of the subject to be inspected, and the display controller 36 that causes the display 41 or the main-body display 32 to display thereon the procedure manual information. According to this configuration, the procedure manual information corresponding to the process in the inspection procedure and the acquired image information are sequentially displayed on the display 41. The inspector thus can easily confirm the working contents of the respective processes and the past inspection results. Thus, a work load for the inspector in the inspection work can be reduced.

In the embodiments, the image storage 38 stores therein the procedure manual information for a predetermined process in the inspection procedure displayed on the display 41 and the image information acquired in the predetermined process while the procedure manual information is displayed in association with each other. Thus, the history of the image information in the same process can be easily managed.

In the embodiments, when the procedure manual information for a predetermined process in the inspection procedure is displayed on the display 41, the display controller 36 displays the image information associated with the procedure manual information on the main-body display. Thus, the inspector can easily perform imaging operation on the subject to be imaged with reference to the image information displayed on the main-body display 32.

In the embodiments, when the procedure manual information for a predetermined process in the inspection procedure is displayed on the display 41, the display controller 36 displays, on the display 41, elapsed time information from the storage of the image information in the image storage 38 in addition to the image information associated with the procedure manual information. Thus, the inspector can easily determine whether the inspection is performed within a specified period.

In the embodiments, the endoscope 10 includes the determinator 37 that determines, based on multiple pieces of the past image information stored in association with the procedure manual information for a predetermined process in the inspection procedure, whether damage has occurred in a target portion of the subject to be imaged. When it is determined that damage has occurred, the procedure manual storage 39 stores therein information for indicating that the damaged portion is present together with the procedure manual information. Thus, the information for indicating that the damaged portion is present and the procedure manual information are displayed on the display 41 of the head mounted display 4 when the corresponding process is started in the next inspection, and the inspector can perform the inspection work while paying attention to the damaged portion. Thus, the inspection accuracy can be easily increased.

In the embodiments, the processes of the inspection procedure are sequentially displayed on the display 41 of the head mounted display 4. Thus the inspector can confirm the respective process while operating the endoscope 10 using both hands and perform the inspection work effectively.

The embodiments above have been represented by way of examples, and are not intended to limit the scope of the invention. In the embodiment, the head mounted display 4 is used as the external equipment. Instead, as the external equipment, any equipment can be used that includes a display for displaying information and is portable. Examples of such equipment include a watch type wearable terminal and a mobile information terminal such as a tablet terminal or a smartphone. When the mobile information terminal such as a tablet terminal or a smartphone is used, a case attachable to an arm of the inspector is preferably used. In the embodiments, the procedure manual information and the image information are displayed on the display 41 of the head mounted display 4. However, the procedure manual information and the image information are not limited to being displayed on the display 41. The procedure manual information and the image information may be displayed on the main-body display 32.

Although the application has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An imaging device, comprising:
an imager configured to image a target;
a main-body display configured to display thereon image information acquired by the imager;
a main-body communicator configured to communicate with external equipment including a display via a network;
a storage configured to store therein the acquired image information and information for indicating a predetermined content; and
a display controller configured to cause the display or the main-body display to display thereon the information for indicating the predetermined content.

2. The imaging device according to claim 1, wherein the storage stores therein the information for indicating the predetermined content, the information being displayed on the display or the main-body display, and the image information acquired while the information for indicating the predetermined content is displayed in association with each other.

3. The imaging device according to claim 2, wherein, when the information for indicating the predetermined content, the information being associated with the image information, is displayed on the display or the main-body display, the display controller causes the display or the main-body display to display thereon the image information.

4. The imaging device according to claim 2, wherein, when the information for indicating the predetermined content is displayed on the display or the main-body display, the display controller displays, on the display or the main-body display, elapsed time information from the storage of the image information in the storage together with the image information associated with the information for indicating the predetermined content.

5. The imaging device according to claim 2, further comprising:
a determinator configured to determine, based on multiple pieces of the image information stored in association with the information for indicating the predetermined content, whether damage has occurred in a portion of the target, wherein
when the determinator determines that the damage has occurred, the storage stores therein information for indicating that the damage is present in the portion of the target together with the information for indicating the predetermined content.

6. The imaging device according to claim 1, wherein the external equipment is a head mounted display.

7. An imaging method that is used by an imaging device including an imager that images a target and a main-body display that displays thereon image information acquired by the imager, the imaging method comprising:
communicating with external equipment including a display via a network;
storing the acquired image information and information for indicating a predetermined content; and
causing the display or the main-body display to display thereon the information for indicating the predetermined content.

8. A non-transitory storage medium that stores therein an imaging program executed by an imaging device including an imager that images a target and a main-body display that displays image information acquired by the imager, the imaging program comprising:
communicating with external equipment including a display via a network;
storing the acquired image information and information for indicating a predetermined content; and
causing the display or the main-body display to display thereon the information for indicating the predetermined content.
